(19) United States
(12) Patent Application Publication
(10) Pub. No.: US 2009/0143093 A1
(43) Pub. Date: Jun. 4, 2009

(54) METHOD AND APPARATUS FOR ADAPTIVE HANDOVER

(75) Inventors: Shankar Somasundaram, Deer Park, NY (US); Rajat P. Mukherjee, Stanford, CA (US); Ulises Olvera-Hernandez, Kirkland (CA); Peter S. Wang, East Setauket, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/324,057

(22) Filed: Nov. 26, 2008

Related U.S. Application Data
(60) Provisional application No. 61/038,716, filed on Mar. 21, 2008.
(60) Provisional application No. 60/991,134, filed on Nov. 29, 2007.

(51) Int. Cl. H04B 7/00

(52) U.S. Cl. 455/525

(57) ABSTRACT

A method and apparatus for adaptive handover includes receiving a time to trigger (TTT) for a first mobility state. A scaling factor is received for a second mobility state. The TTT for the second mobility state is determined by scaling the first mobility state with the scaling factor for the second mobility state.

### CROSS REFERENCE TO RELATED APPLICATIONS

This application claims the benefit of U.S. Provisional Application No. 61/038,716, filed Mar. 31, 2008, and 60/991,134, filed Nov. 29, 2007, which are incorporated by reference as if fully set forth.

### FIELD OF INVENTION

This application is related to wireless communications.

### BACKGROUND

Current efforts for the Third Generation Partnership Project (3GPP) Long Term Evolution (LTE) program are directed toward developing new technology and new architectures for new methods and configurations. This effort is directed to provide improved spectral efficiency, reduced latency and better utilization of radio resources for faster user experiences and richer applications and services with less associated cost.

Depending on its location, a wireless transmit/receive unit (WTRU) may be in contact with more than one base station. Depending on environmental factors and the distance between the WTRU and the base stations, one base station may have a better signal to the WTRU than another base station in range of the WTRU. When the WTRU detects a signal of better quality than the signal currently used by the WTRU and the base station servicing it, a handover procedure may be performed to transfer the WTRU's communications to the base station with the better signal.

In order to determine whether or not one base station has a better signal quality than another, the WTRU may periodically compare the signal quality of base stations within its range. One of the ways that the WTRU determines when to make these comparisons is through the use of a time to trigger (TTT). With the use of a scaled TTT, an adaptive handover procedure may be utilized. Accordingly, it would therefore be beneficial to provide a method and apparatus for performing and adaptive handover.

### SUMMARY

A method and apparatus for adaptive handover is disclosed. The method includes receiving a time to trigger (TTT) for a first mobility state. A scaling factor is received for a second mobility state. The TTT for the second mobility state is determined by scaling the first mobility state with the scaling factor for the second mobility state.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of WTRUs and an evolved Node-B (eNB);

FIG. 2 is an example functional block diagram of a WTRU and the eNB of FIG. 1; and

FIG. 3 is a flow diagram of a method of performing an adaptive handover.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

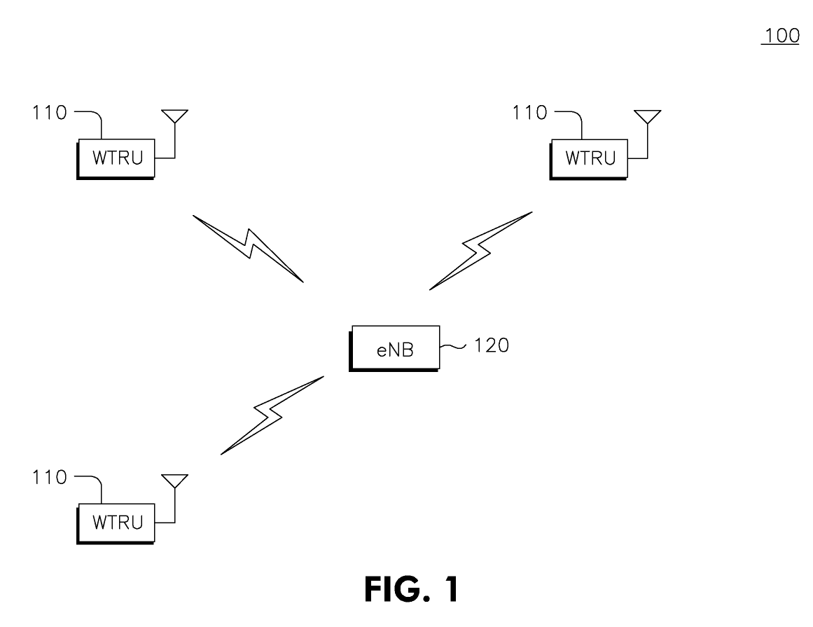

FIG. 1 shows an example wireless communication system 100 including a plurality of WTRUs 110 and an eNB 120. As shown in FIG. 1, the WTRUs 110 are in communication with the eNB 120. It should be noted that, although an example configuration of WTRUs 110 and an eNB 120 is depicted in FIG. 1, any combination of wireless and wired devices may be included in the wireless communication system 100.

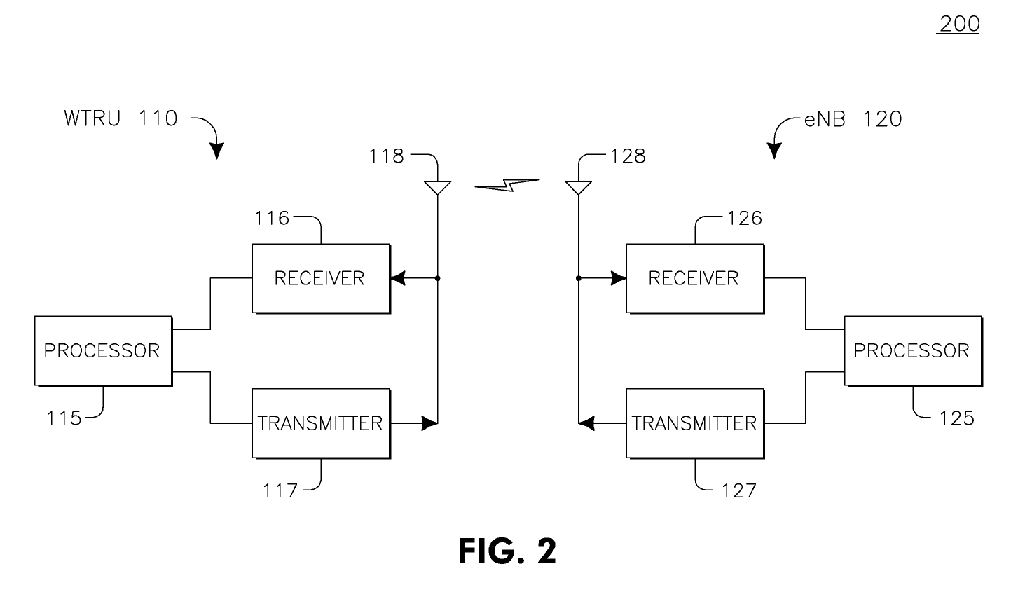

FIG. 2 is an example functional block diagram 200 of a WTRU 110 and the eNB 120 of the wireless communication system 100 of FIG. 1. As shown in FIG. 2, the WTRU 110 is in communication with the eNB 120.

In addition to the components that may be found in a typical WTRU, the WTRU 110 includes a processor 115, a receiver 116, a transmitter 117, and an antenna 118. The receiver 116 and the transmitter 117 are in communication with the processor 115. The antenna 118 is in communication with both the receiver 116 and the transmitter 117 to facilitate the transmission and reception of wireless data. The processor 115 of the WTRU 110 is configured to perform an adaptive handover procedure.

In addition to the components that may be found in a typical eNB, the eNB 120 includes a processor 125, a receiver 126, a transmitter 127, and an antenna 128. The receiver 126 and the transmitter 127 are in communication with the processor 125. The antenna 128 is in communication with both the receiver 126 and the transmitter 127 to facilitate the transmission and reception of wireless data. The processor 125 of the eNB 120 is configured to perform an adaptive handover procedure.

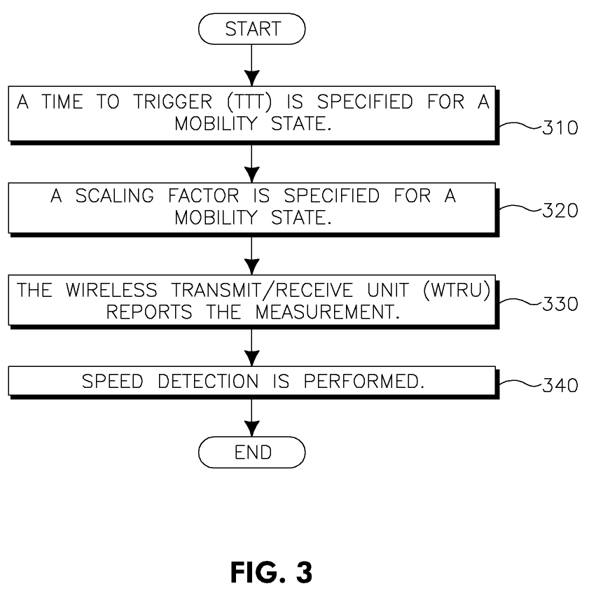

FIG. 3 is a flow diagram of a method 300 of performing an adaptive handover. In step 310, a TTT is specified for each mobility state, and a scaling factor may be specified for each mobility state (step 320). That is, one TTT may be specified for one of the mobility states, (i.e., low mobility, medium mobility, and high mobility), along with at least one scaling factor for the other mobility states. The scaling factor may then be applied to the specified TTT to determine a TTT for another mobility state.

For example, one TTT may be signaled, (e.g., by the network), for a low mobility state, (e.g., a stationary WTRU), and two different scaling factors for the medium and high mobility states, (e.g., a WTRU in motion). In this manner, the TTTs for the medium and high mobility states may be calculated by scaling the signaled TTT for the low mobility state with the respective scaling factors. The value of the scaling factor may be in the range from 0 to 1 in 0.1 steps. It should be noted that other combinations may also be utilized for specifying the TTT and scaling factors for mobility states. For example, the TTT could be specified for the medium mobility state and scaling factors could be specified for the high and low mobility states instead.

Alternatively, one scaling factor could be specified and signaled by the network to the WTRU 110, (e.g., via the eNB 120), and a scaling offset could be defined that would aid the WTRU 110 in calculating the second scaling factor. In this manner, the WTRU 110 could calculate the scaled TTT for one mobility state by using the scaling factor and the scaled TTT for the other mobility state by using the scaling factor with the offset. For example, the second scaling factor could be calculated in accordance with the following equations:

Second Scaling Factor=First Scaling Factor+Offset; Equation (1)

or

Second Scaling Factor=First Scaling Factor*Offset. Equation (2)

Other combinations of providing TTTs and scaling factors may also be utilized in steps 310 and 320. For example, two different TTTs may be specified, one for low mobility states and one for a high mobility state. Two scaling factors may be also be specified. In one example, when the WTRU 110 is in a medium mobility state, it can apply the scaling factor for the low mobility TTT and calculate the TTT to be used for the medium mobility state. On the other hand, when the WTRU 110 is in a high mobility state, it can apply the scaling factor applicable to the high mobility TTT in order to calculate the high mobility TTT.

In another example where two TTTs are specified, (e.g., a “normal” or low mobility TTT and a high mobility TTT), only one scaling factor may be specified. For example, a scaling factor may be specified for low mobility, or stationary, WTRUs 110. Accordingly, when the WTRU 110 is in a medium mobility state, it can apply the scaling factor for the normal TTT in order to calculate the TTT for the medium mobility state. When the WTRU 110 is in the high mobility state, then, it could apply directly the TTT for the high mobility state.

A TTT value along with a scaling factor could also be utilized where an offset is provided per mobility state. In this example, when the WTRU 110 is in any mobility state, it can determine the TTT by multiplying the TTT value by the scaling factor and adding the offset specific to the mobility state the WTRU 110 is in.

In yet another example, the WTRU 110 may utilize any combination of the TTT and scaling factor combination described above, while being given a single offset value to be used when a mobility state is detected and the TTT is scaled. For example, the WTRU 110 could be given the TTT for the low mobility state and scaling factors for all three mobility states. Along with this, the WTRU 110 could also be provided an offset to add when it calculates the TTT for a given state.

Once the TTT condition is met and the WTRU 110 is stationary, (i.e., in a low mobility state), a measurement report is signaled to the network by the WTRU 110 (step 330). The measurement report may inform the network that a neighbor cell is above a threshold and may include information relating to the neighbor cell's ID. In addition, the WTRU 110 may report whether or not the serving cell is below a threshold.

If the WTRU 110 scales the TTT, the WTRU 110 may also report to the network that a mobility condition has been met in addition to providing the corresponding mobility condition. That is, the WTRU 110 may report to the network whether or not a low, medium, or high mobility condition has been met, and/or its existing mobility condition. This information could be sent in a measurement report irrespective of whether or not the TTT is scaled.

The measurement report signaling (step 330) may be triggered by a number of events. For example, a neighbor cell measurement criteria, a serving cell measurement criteria, a periodic reporting requirement, and the like, may trigger the signaling of the measurement report. Additionally, the WTRU 110 may embed its mobility condition in a report that is generated for events such as described above. That is, when a serving or neighbor cell is above or below a pre-determined threshold, the WTRU 110 may embed its mobility condition in a report signaled to the network upon those conditions, or any other pre-defined condition. The signaling could be via a radio resource controller (RRC) layer, medium access control (MAC) layer, layer 1, or any other type of signaling, and may be specified in the standards. The serving cell or neighboring cell measurements may also be included in the measurement report.

Other conditions where the WTRU 110 may report its mobility condition include when the WTRU 110 is reconfigured or when the WTRU 110 is handed over to another cell. The WTRU 110 could report its mobility condition when it establishes or releases a connection with the network, (e.g., an RRC connection re-establishment request or RRC connection release). The network can configure the WTRU 110 to report its computed mobility state or any other information. In addition, any of the parameters or thresholds could be pre-configured, defined in the standard, or signaled by the network via a system information message, RRC message, or other signaling.

Another way to report the measurement is to provide the measurement report as if the WTRU 110 is stationary, (i.e., low mobility), and as if the TTT has expired. In this manner, the WTRU 110 provides information as to whether a neighboring cell measurement is above a threshold or the serving cell measurement is below a threshold. A time window could also be utilized in which the WTRU 110 measures the serving cell. If the serving cell stays below a threshold during the entire duration of the time window, reduces at a pre-defined rate during the window, when the TTT expires, the WTRU 110 can send the measurement report along with any information relating to the serving and neighboring cells. It should also be noted that the WTRU 110 may send a measurement report even if the serving cell is above a pre-defined threshold, and the network may utilize the information to delay a potential handover as the serving cell may be in a position to sustain the connection with the WTRU 110.

In addition, if the WTRU 110 is configured with periodic or event triggered periodic reporting, the WTRU 110 may scale an indicated reporting interval along with scaling the TTT. This scaling of the reporting interval could be utilized to allow the WTRU 110 to send measurement reports more frequently, and the same or other parameters could be utilized for scaling the interval that are utilized for scaling the TTT. In addition, if the intervals for periodic or event triggered reporting are scaled, the WTRU 110 may change the intervals depending on its mobility state. For example, if the WTRU 110 scaled the interval when in a high mobility state, the interval may be re-scaled appropriately if the WTRU 110 enters another mobility state.

Once the network receives the measurement report, the network may signal changes in parameters or procedures for the WTRU 110 to perform via a handover command. The parameters may be signaled in a system information broadcast (SIB) or any other RRC or configuration message. In addition, the parameters may be stored by the WTRU 110 and an information element (IE) may be signaled to the WTRU 110 to indicate whether the WTRU 110 is to apply the parameters. For example, the network could signal the parameter and an IE that indicates the WTRU 110 should not apply scaling of the TTT or any other parameter. In this case, when the WTRU 110 is to scale the parameters, then the network need only signal an IE that indicates to the WTRU 110 to begin applying them. The IE could take the form of an enumerated field, such as a “Speed Dependent Scaling: True/False” IE.

It should also be noted that several scenarios may arise regarding the scaling of the TTT. For example, the high speed mobility condition may occur when the WTRU 110 is still in the process of counting its TTT. For example, the WTRU 110 may be in a stationary mobility state and started its TTT count when the high mobility condition is met. Once the scaling of the TTT occurs, the WTRU 110 may determine that the actual count has already been passed. Accordingly, if the WTRU 110 encounters this situation, it may immediately trigger its measurement report. For example, once the TTT condition is met, the WTRU 110 may start an internal timer and compare the value of the timer against a TTT. If the timer is equal to or greater than the TTT, then the WTRU 110 may determine that the TTT is met and send the measurement report. Also, when the high mobility condition is met, the TTT could be scaled to a second value that is lower than the first value. In such a scenario, if the value of the timer is determined to be greater than that second value, the WTRU 110 may trigger a measurement report.

Alternatively, if the actual count has not passed and a new mobility state is determined, the WTRU 110 may count down to the TTT and ignore the new scaled TTT until the measurement report is triggered. The WTRU 110 may wait a predetermined time, or “hysteresis” time, after the count expires before triggering the measurement report in step 330. The hysteresis time may be employed whenever the scaling of the TTT is used.

If the mobility state changes after the WTRU 110 sends the measurement report (step 330), then the WTRU 110 may dynamically adjust the scaled parameters, (e.g., the interval for periodic or event triggered reporting). Even with the scaling of parameters, the WTRU 110 may encounter a situation where a neighbor cell rises above and below a pre-determined threshold where the WTRU 110 does not start the TTT counter. Accordingly, the WTRU 110 may scale the hysteresis time or threshold value to account for this occurrence, as well scaling the measurement intervals so that the WTRU 110 may measure neighboring cells more frequently. The determination of whether to scale the hysteresis time, as well as any other parameters, may be determined by the network and signaled to the WTRU 110.

Additionally, the type of cell or topology of the cell could be utilized as a factor to determine the scaling factor. For example, if the cell is a home Node-B (HNB) cell or is a large cell, the WTRU 110 may scale the TTT and other parameters differently than when the cell is not an HNB cell or is a smaller cell. In the case of an HNB cell, the WTRU 110 may not apply any mobility parameters.

One of the ways in which the mobility state of the WTRU 110 may be determined is by performing speed detection (step 340). For example, to detect what mobility state the WTRU 110 is in, it may determine the number of handovers performed, ‘N’, in a period of time, ‘T’. However, one of the issues that may arise using this technique is that a cell that is handed off to and then handed back to may wind up being counted twice. Accordingly, for the speed detection step 340, the WTRU 110 may keep track of the cells to which a handover was performed and only count new handovers in the counting process.

For example, if the WTRU 110 is handed off from cell A to B to C to A to B to A, then the WTRU 110 may count the number of handovers, N, as three (3) as opposed to five (5). That is, the handovers from A to B, B to C, and C to A are considered new handovers since the subsequent handovers from A to B and then B to A are from cells that have already been counted. In addition, the WTRU 110 may have a transmission (Tx) timer signaled in which it only counts new handovers that occur during the Tx interval. The Tx interval could be the same as, or less, than ‘T’. A handover to a cell to which the WTRU 110 was already connected may be performed outside of the Tx timer interval and could be counted as part of the speed detection procedure. For example, if the WTRU 110 was already camped on cell A, and the WTRU 110 is handed over to cell A even after the time interval Tx, the WTRU 110 could count that handover.

In another example, the WTRU 110 may track the last connected cell and not count it as part of the number of handovers. That way, a “ping-pong” effect may be avoided. For example, if the WTRU 110 hands over from cell A to B to C to A to B to A, then the number of handovers may be counted as four (4) instead of five (5). That is, the handover from A to B to A is counted as one handover since the WTRU 110 was just connected to cell A before being handed over to cell B and back. The WTRU 110 may also track cells detected during the measurement process, such as in a list, and measure its mobility by the frequency of the updates to the list.

In a variation of counting handovers, the WTRU 110 may count cells as part of the speed detection step 340. That is, if the WTRU 110 hands over from cell A to B to C to A to B to A over the time period ‘T’, as in the previous example, the number of cells handed over to would be counted as six (6).

In addition, any of the counting techniques described above could be utilized to count cells instead of handovers. It should also be noted that the serving signal strength could be used as a criteria for speed detection. Also, although the terms low, medium, and high mobility states have been used above to describe the various mobility states of the WTRU 110, other terms may also be utilized and other gradations of mobility states beyond the three described may be employed. For example, as mentioned above, the “low” mobility state could also be referred to as a “stationary” mobility state, a “normal” mobility state, or any other term.

It should also be noted that the WTRU 110 may utilize reference symbol received power (RSRP), reference symbol received quality (RSRQ), or received signal code power (RSCP), for signal measurements.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for adaptive handover, comprising:
receiving a time to trigger (TTT) for a first mobility state;
receiving a scaling factor for a second mobility state; and
determining the TTT for the second mobility state by scaling the first mobility state with the scaling factor for the second mobility state.

2. The method of claim 1, further comprising receiving a scaling factor for a third mobility state and determining the TTT for the third mobility state by scaling the first mobility state with the scaling factor for the third mobility state.

3. The method of claim 1 wherein the first mobility state is a low mobility state and the second mobility state is a medium or high mobility state.

4. The method of claim 1 wherein the scaling factor is in the range of zero (0) to one (1).

5. The method of claim 4 wherein the scaling factor is incremented in one-tenth increments.

6. A method for adaptive handover, comprising:
tracking a number of cells for which a handover is performed; and
counting new handovers to determine a mobility speed.

7. The method of claim 6 wherein a new handover includes a handover to or from a cell that a handover has not already previously been performed.

8. The method of claim 6, further comprising tracking a last connected cell and not counting a handover to the last connected cell as a new handover.

9. The method of claim 6, further comprising counting new handovers during a predefined timing interval.

10. The method of claim 9 wherein a cell to which the WTRU was previously connected is counted as a new handover when the handover is performed outside of the predefined timing interval.

11. A wireless transmit/receive unit (WTRU), comprising:
a receiver;
a transmitter; and
a processor in communication with the receiver and the transmitter, the processor configured to receive a time to trigger (TTT) for a first mobility state, receive a scaling factor for a second mobility state, and determine the TTT for the second mobility state by scaling the first mobility state with the scaling factor for the second mobility state.

12. The WTRU of claim 11 wherein the processor is further configured to receive a scaling factor for a third mobility state and determine the TTT for the third mobility state by scaling the first mobility state with the scaling factor for the third mobility state.

13. The WTRU of claim 11 wherein the first mobility state is a low mobility state and the second mobility state is a medium or high mobility state.

14. The WTRU of claim 11 wherein the scaling factor is in the range of zero (0) to one (1).

15. The WTRU of claim 14 wherein the scaling factor is incremented in one-tenth increments.

16. A wireless transmit/receive unit (WTRU), comprising:
a receiver;
a transmitter; and
a processor in communication with the receiver and the transmitter, the processor configured to track a number of cells for which a handover is performed, and count new handovers to determine a mobility speed.

17. The WTRU of claim 16 wherein a new handover includes a handover to or from a cell that a handover has not already previously been performed.

18. The WTRU of claim 16 wherein the processor is further configured to track a last connected cell and not count a handover to the last connected cell as a new handover.

19. The WTRU of claim 16 wherein the processor is further configured to count new handovers during a predefined timing interval.

20. The WTRU of claim 19 wherein the processor is further configured to count a cell to which the WTRU was previously connected as a new handover when the handover is performed outside of the predefined timing interval.
